(19) United States
(12) Patent Application Publication
(10) Pub. No.: US 2005/0173265 A1
(43) Pub. Date: Aug. 11, 2005

(54) Sensor device for exhaust gases of internal combustion engines and operating and analyzing method

(76) Inventor: Roland Stahl, Freiberg (DE)

Correspondence Address: KENYON & KENYON, ONE BROADWAY, NEW YORK, NY, 10004, US

(21) Appl. No.: 11/022,175

(22) Filed: Dec. 23, 2004

(30) Foreign Application Priority Data
Dec. 23, 2003 (DE) 103 60 775.7

(51) Int. Cl. G01N 27/26

(52) U.S. Cl. 205/783.5; 204/426; 204/424

(57) ABSTRACT

A sensor device for detecting oxygen concentration at different points of an exhaust system of an internal combustion engine is described, including a first exhaust gas sensor which is situated upstream from a catalytic converter volume and which provides a first signal for a rapid fuel/air ratio control loop of the internal combustion engine and a second exhaust gas sensor which is situated downstream from the catalytic converter volume and which provides a second signal. The device is characterized in that the first exhaust gas sensor as well as the second exhaust gas sensor both have an outer pump electrode, an inner pump electrode, a Nernst electrode, and a reference electrode and that the first exhaust gas sensor is connected to a first operating and analyzing circuit and that the second exhaust gas sensor is connected to a second operating and analyzing circuit, at least the first operating and analyzing circuit or the second operating and analyzing circuit operating the connected first exhaust gas sensor or the second exhaust gas sensor as a Nernst sensor.

### FIELD OF THE INVENTION

The present invention relates to a sensor device for detecting the oxygen concentration at different points of an exhaust system of an internal combustion engine, including a first exhaust gas sensor situated upstream from a catalytic converter volume providing a first signal for a rapid fuel/air ratio control loop of the internal combustion engine, and a second exhaust gas sensor situated downstream from the catalytic converter volume providing a second signal. The present invention also relates to a method for operating such a sensor device.

### BACKGROUND INFORMATION

In a complete, stochiometric combustion of hydrocarbon mixtures, such as gasoline and/or diesel fuel with air, only molecular nitrogen, carbon dioxide, and water are created as combustion products. If the supplied combustion air is stochiometrically metered in relation to the supplied fuel, but there was inadequate reaction time, then, in addition to these three gases, additional gases appear which, compared to the named end products, are either still lacking oxygen or contain an excess of oxygen.

According to the 2-sensor concept described in German Patent No. 35 00 594, the air quantity flowing into the internal combustion engine is measured and a matching fuel quantity is metered using the rapid control loop. As a measure for the fuel/air ratio in the combustion chambers of the internal combustion engine, the first exhaust gas sensor detects an oxygen concentration upstream from a catalytic converter. A solid electrolyte, zirconium dioxide for example, is used for detecting the oxygen concentration, the solid electrolyte being conductive for oxygen ions and for separating the exhaust gas from a reference atmosphere, generally the ambient air. Different oxygen concentrations in the exhaust gas and in the reference atmosphere generate an oxygen ion flow through the solid electrolyte, resulting in a potential difference between an outer electrode facing the exhaust gas and an inner electrode facing the reference atmosphere. This difference in potential is detected with high resistance and is used as an input signal for the first control loop.

An inference from the difference in potential with respect to the fuel/air ratio is only possible when a thermodynamic gas balance materializes in the exhaust gas. This condition is met with the aid of catalytically active electrodes which bring about a complete conversion into nitrogen, carbon dioxide, and water locally at the electrode facing the exhaust gas. In this case, the characteristic curve of this sensor has a jumping characteristic under stochiometric conditions (lambda=1). If high concentrations of exhaust gas components, which are not thermally balanced, are only partially converted, the characteristic curve of the sensor shows a shift in the position of the jump.

According to German Patent No. 35 00 594, a second control loop superimposes the first control loop, the second control loop having a second exhaust gas sensor which is situated downstream from a three-way catalytic converter as a catalytic converter volume. The catalytic converter volume brings about a complete thermal balance of the exhaust gas, so that the second exhaust gas sensor may detect the oxygen concentration in the exhaust gas with increased accuracy. However, in addition to this advantage, positioning the second exhaust gas sensor downstream from the catalytic volume has the disadvantage that changes in the oxygen concentration in the raw exhaust gas of the internal combustion engine are dampened to a certain extent by storage effects of the catalytic converter volume causing the second exhaust gas sensor to respond to such changes only comparatively slowly. Because of this reason, the first exhaust gas sensor is primarily used for regulating the fuel/air mixture and the second control loop is used for a superimposed correction, e.g., via a setpoint shift for the first control loop.

In addition to this known concept of using two exhaust gas sensors having jumping characteristics, there are also concepts in which a broadband sensor as the control sensor is positioned upstream from the catalytic converter volume. Such a broadband sensor is explained on page 524 of the Automotive Handbook, 23^{rd} edition, for example. The broadband sensor has a continuous, non-jumping characteristics curve. In contrast to a sensor having a jumping characteristic which, to a certain extent, only provides information about the sign of the deviation of an oxygen concentration from a setpoint value, the continuous characteristics curve also allows inferences about the absolute value of the deviation. Moreover, the information about the oxygen concentration is continuously and not only temporarily available while passing through the stochiometric point. However, the sensor having a jumping characteristic has the advantage over such a broadband sensor in that the position of the stochiometric point may be detected more accurately due to the jumping signal curve. For this reason, a sensor having a jumping characteristic is also used as a reference sensor in 2-sensor concepts having a broadband sensor as a control sensor positioned upstream from the catalytic converter volume.

Furthermore, concepts for operating an internal combustion engine are known in which the internal combustion engine is only operated with a stochiometric fuel/air mixture at medium load and high load, and in which operation with excess air is preferred at low load. Such lean operation generates nitrogen oxides on a larger scale which, at simultaneously high oxygen concentrations, are difficult to convert. The continuous SCR method (selective catalytic reduction), the operation and monitoring of which would arguably require an NOₓ sensor, is known for converting large quantities of nitrogen oxide. Another method, but with discontinuous action, uses an NOₓ storage catalytic converter which stores nitrogen oxides contained in the lean exhaust gas and releases them in converted form in short regeneration phases characterized by a reducing exhaust gas atmosphere.

The phase in which nitrogen oxides are stored may be monitored using an NOₓ sensor. The regeneration phase may alternatively or additionally be monitored using an oxygen-sensitive exhaust gas sensor. A very cost-effective method provides for the reference sensor of lambda=1 operation to also be used as a monitoring sensor for the regeneration of the NOₓ, storage catalytic converter. However, during the use of conventional exhaust gas sensors having jumping characteristics for monitoring the regeneration phases, it has been found that over-sensitive reactions may occur in the sensor signal curves which make accurate control of the regeneration phase difficult. Alternatively to the reference sensor having a jumping characteristic, it could also be conceivable to use the broadband sensor for controlling the regeneration and the first control loop. However, due to high accuracy demands on the control, the use of the broadband sensor as a reference sensor is viewed critically. Against this background, exhaust gas sensors having different characteristics are necessary for fulfilling different control and monitoring tasks in the exhaust system of an internal combustion engine. Structurally different exhaust gas sensors have previously been used for this.

In the interest of decreasing manufacturing and warehousing costs in the spare parts market, it would be desirable to reduce the number of different types of exhaust gas sensors in an exhaust gas after-treatment system. Against this background, the object of the present invention is to provide a sensor device for detecting the oxygen concentration at different points of an exhaust gas after-treatment system of an internal combustion engine which meets the above-described requirements and uses a reduced number of exhaust gas sensor types. Moreover, the object of the present invention is to provide a method for operating such a sensor device using a reduced number of different sensors.

This object is achieved using a sensor device of the type initially described in that the first sensor as well as the second sensor have one outer pump electrode, one inner pump electrode, one Nernst electrode, and one reference electrode, in that the first exhaust gas sensor is connected to a first operating and analyzing circuit and the second exhaust gas sensor is connected to a second operating and analyzing circuit, at least the first or the second operating and analyzing circuit operating the connected first or second exhaust gas sensor as a Nernst sensor. Furthermore, the object is achieved using a method of the type initially described in that at least one of the exhaust gas sensors of such a sensor device is operated as a Nernst sensor using its sensor-specific operating and analyzing circuit. The inner pump electrode and the Nernst electrode may be implemented as a combined electrode. The combined electrode then executes both functions, i.e., the function of an inner pump electrode and the function of a Nernst electrode. Using the reference electrode, the outer pump electrode, and the combined inner pump and Nernst electrode, the present invention thus only requires three electrodes of different design.

### SUMMARY OF THE INVENTION

The object of the present invention is achieved entirely by these features. The fact that the first exhaust gas sensor as well as the second exhaust gas sensor has the mentioned electrodes offers the option to adapt each of the two exhaust gas sensors to a predefined use via the design of its operating and analyzing circuit. Such an exhaust gas sensor operates either as an exhaust gas sensor having a jumping characteristic or as a broadband sensor, depending on the design of its operating and analyzing circuit. Moreover, the function as a sensor having a jumping characteristic offers the possibility to change the position of the jump in such a way that such an exhaust gas sensor may also be used for monitoring and controlling the regeneration of an NOₓ storage catalytic converter. This makes it possible to meet all requirements described further above using a single configuration of an exhaust gas sensor. The manufacturing of a sensor device having multiple exhaust gas sensors as well as the warehousing of the exhaust gas sensors for a spare parts market are considerably simplified as a result.

It is preferred for the first operating and analyzing circuit to operate the first exhaust gas sensor as a Nernst sensor, i.e., as a sensor having a jumping characteristic, and to pick off a Nernst voltage as the difference of a potential of the outer pump electrode and a potential of the reference electrode. This design provides a quickly responding exhaust gas sensor which is particularly suited as a control sensor positioned upstream from the catalytic converter volume within the scope of a two-step control in which only the sign of the system deviation is analyzed.

It is preferred alternatively for the first operating and analyzing circuit to operate the first exhaust gas sensor as a broadband sensor, the outer pump electrode together with the inner pump electrode and/or the Nernst electrode and an ion-conductive volume situated between the named electrodes forming a pump cell which is operated by a pump current which is dependent on the difference between a potential of the Nernst electrode and/or the inner pump electrode and the potential of the reference electrode.

This design provides a broadband sensor which, as a control sensor situated upstream from the catalytic converter volume, allows a control action in which, in addition to the sign of a system deviation, the actual value of a system deviation may also be processed.

Furthermore, it is preferred for the second operating and analyzing circuit to operate the second exhaust gas sensor as a Nernst sensor.

The second exhaust gas sensor is thereby operated with maximum accuracy in a way which is desirable for use as a reference sensor.

A further preferred embodiment is characterized in that the second operating and analyzing circuit operates the second exhaust gas sensor as a reference sensor for the first control loop without connection to an outer pump electrode, the second operating and analyzing circuit picking off a Nernst voltage as a difference between a potential of the Nernst electrode and/or the inner pump electrode and a potential of the reference electrode.

A connection of the outer pump electrode to the operating and analyzing circuit may be omitted by connecting the exhaust gas sensor as a Nernst reference sensor. Due to this connection, the accuracy with which the exhaust gas sensor detects the oxygen concentration downstream from the catalytic converter volume is increased at the expense of its response speed. However, the loss in response speed is not critical since the reference sensor is not required to be quick anyway. In the event of higher demands on the response speed, a Nernst voltage may also be measured between the outer pump electrode and the reference electrode in the case of the reference sensor downstream from the catalytic converter volume. By alternately or simultaneously measuring and comparing the voltages detected between the outer pump electrode and the reference electrode as well as between the inner pump electrode and/or the Nernst electrode and the reference electrode, information may also potentially be obtained for an on-board diagnosis.

It is also preferred for the second operating and analyzing circuit to operate the second exhaust gas sensor using a pump current flowing over the outer pump electrode and for the second operating and analyzing circuit to pick off a Nernst voltage as a difference between a potential of the Nernst electrode and/or the inner pump electrode and a potential of the reference electrode.

The particular advantage of this embodiment is that the pump current flowing over the outer pump electrode affects the oxygen concentration and thus the potential at the Nernst electrode and/or at the inner pump electrode in a defined way which results in a defined shift of the jump in the sensor characteristics curve. Due to this shift of the jump, the over-sensitivity initially mentioned in connection with monitoring and/or controlling a regeneration phase of an NOₓ storage catalytic converter may be dampened or even over-compensated for. The exhaust gas sensor may thereby meet the demands made on monitoring and/or controlling of such regeneration phases.

Furthermore, it is preferred for the second operating and analyzing circuit to provide a constant pump current.

Alternatively, it is preferred for the second operating and analyzing circuit to apply a constant pump potential to the outer pump electrode.

As a rule, a constant current is necessary in order to achieve a defined shift. At a constant resistance, i.e., in particular at a constant sensor temperature, a constant potential of the outer pump electrode drives a constant current through the solid electrolyte. Both embodiments are therefore exchangeable when the temperature of the exhaust gas sensor is sufficiently constant during operation, which is often the case.

A further embodiment is characterized in that the first exhaust gas sensor and the second exhaust gas sensor are identical. This embodiment has the advantage that both exhaust gas sensors are exchangeable with each other. The manufacture of a unique type of exhaust gas sensor in a single manufacturing line is sufficient for providing exhaust gas sensors having the properties required for different tasks.

Alternatively, it is preferred for the first exhaust gas sensor to differ from the second exhaust gas sensor only with respect to a modified diffusion barrier.

This embodiment is advantageous when the second exhaust gas sensor is to be used for monitoring an NOₓ storage catalytic converter without straining it by too high a pump current. This design may also be manufactured on the same manufacturing line as the exhaust gas sensors intended for other applications. Applying a porous paste generally creates the diffusion barrier, so that only the step of applying the porous paste must be changed within the manufacturing process.

### BRIEF DESCRIPTION OF THE DRAWINGS

FIG. 1 shows an internal combustion engine including an exhaust system, having a control sensor, a reference sensor, and an additional sensor for monitoring and/or controlling the regeneration of an NOₓ storage catalytic converter.

FIG. 2 shows a sectional representation of the exhaust gas sensor including a first embodiment of a sensor-specific connection.

FIG. 3 shows the exhaust gas sensor including a second embodiment of a connection.

FIG. 4 shows the exhaust gas sensor including a third embodiment of the connection.

FIG. 5 shows the exhaust gas sensor including a fourth embodiment of the connection.

### DETAILED DESCRIPTION

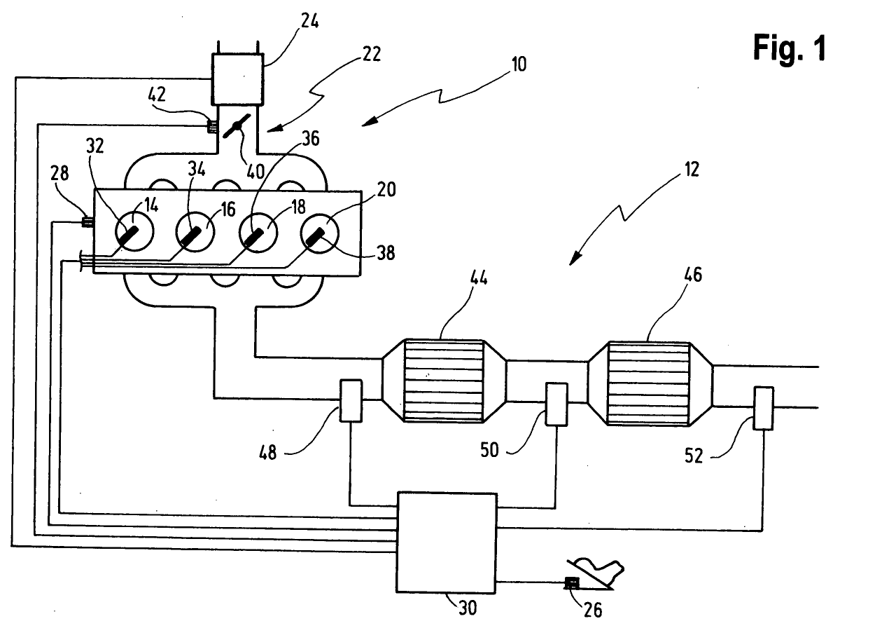

FIG. 1 shows an internal combustion engine 10 including an exhaust system 12. Combustion chambers 14, 16, 18, 20 of internal combustion engine 10 are filled with air from an intake system 22, the quantity of air flowing into combustion chambers 14, 16, 18, 20 being detected by an air flow sensor 24. Base values for fuel quantities, which are metered via injectors 32, 34, 36, and 38 for filling combustion chambers 14, 16, 18, 20 with air, are determined in a control unit 30 from the signal of air flow sensor 24 and/or an accelerator pedal sensor 26, and from the signal of an engine speed sensor 28. If needed, control unit 30 also controls the position of an optional throttle valve 40 via an actuator 42.

Exhaust gases from combustion processes in combustion chambers 14, 16, 18, and 20 are collected by exhaust system 12 and pollutants contained in the exhaust gas are converted by at least one catalytic converter volume 44. Catalytic converter volume 44 may be implemented as a conventional 3-way catalytic converter, for example. An additional catalytic converter volume 46, which is used, for example, as an NOₓ storage catalytic converter for converting nitrogen oxides emitted during operation of internal combustion engine 10 with excess air, may be situated downstream from first catalytic converter volume 44.

A first exhaust gas sensor 48 detects the oxygen concentration in the exhaust gas upstream from first catalytic converter volume 44. Together with control unit 30 as a controller and injectors 32, 34, 36, 38 as actuators, first exhaust gas sensor 48 forms a rapid fuel/air ratio control loop for internal combustion engine 10. A second exhaust gas sensor 50 is situated downstream from catalytic volume 44 in exhaust system 12 and, together with control unit 30, forms a second control loop which controls the first control loop. If, for example, first exhaust gas sensor 48 is systematically wrong because of an unbalanced exhaust gas, the deviation from the correct value is detected by second exhaust gas sensor 50 and is used via control unit 30 for changing a setpoint value for the first control loop, for example, so that the first control loop adjusts to the correct setpoint value despite mismeasurements of first exhaust gas sensor 48. Another second exhaust gas sensor 52 is situated downstream from second catalytic volume 46, alternatively or additionally to second exhaust gas sensor 50. Exhaust gas sensors 48, 50, and 52 are preferably exchangeable with each other and fulfill different tasks due to the fact that their individual operating and analyzing circuits differ from one another. The individual operating and analyzing circuits are preferably integrated into control unit 30.

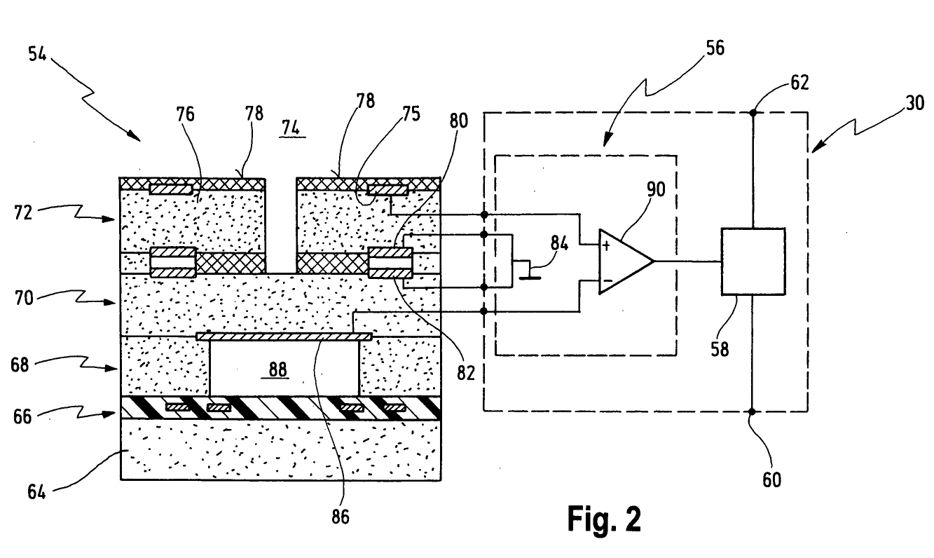

FIG. 2 shows a sectional view of an exhaust gas sensor 54 together with an operating and analyzing circuit 56 integrated into control unit 30. Operating and analyzing circuit 56 is connected to computer and memory modules 58 of control unit 30 which additionally receive input signals of sensors 26, 28 via an input 60 and which control actuators 32, 34, 36, 38, and 42 via an output 62. Exhaust gas sensor 54 according to FIG. 2 may be used as exhaust gas sensor 48, or 50, or 52 according to FIG. 1. The suitability for the appropriate application arises from the connection to an analyzing circuit, analyzing circuit 56 according to FIG. 2 making exhaust gas sensor 54 predestined for use as control sensor 48.

Exhaust gas sensor 54 is preferably made up of multiple layers or foils. A heater foil 64 carries a heater structure 66 onto which a reference channel foil 68 is applied. A pump foil 72 is situated on top of an intermediate foil 70 which is situated on top of reference channel foil 68. Cited foils 64, 68, 70, and 72, at least though intermediate foil 70 and pump foil 72, are made of an oxygen ion-conducting material, e.g., a zirconium dioxide solid electrolyte.

Exhaust gas sensor 54 shown in FIG. 2 has an outer pump electrode 76, which faces exhaust gas 74 and is protected by a gas-permeable porous layer 78. In the embodiment according to FIG. 2, an inner pump electrode 80 and a Nernst electrode 82 are either not connected to analyzing circuit 56 or are connected in analyzing circuit 56 to a neutral reference potential 84. A reference electrode 86 is exposed to a reference atmosphere which prevails in reference channel 88. Via a connection of reference channel 88 to the ambient air outside of exhaust system 12, the reference atmosphere may be air, for example. A difference in the oxygen concentrations in exhaust gas 74 and in reference channel 88 generates a balancing oxygen-ion diffusion flow through pump foil 72 and intermediate foil 70 which results in different electrical potentials at outer pump electrode 76 and reference electrode 86. The potential difference, also referred to as the Nernst voltage, is detected by operational amplifier 90 of operating and analyzing circuit 56 with high resistance and is transferred to computer 58.

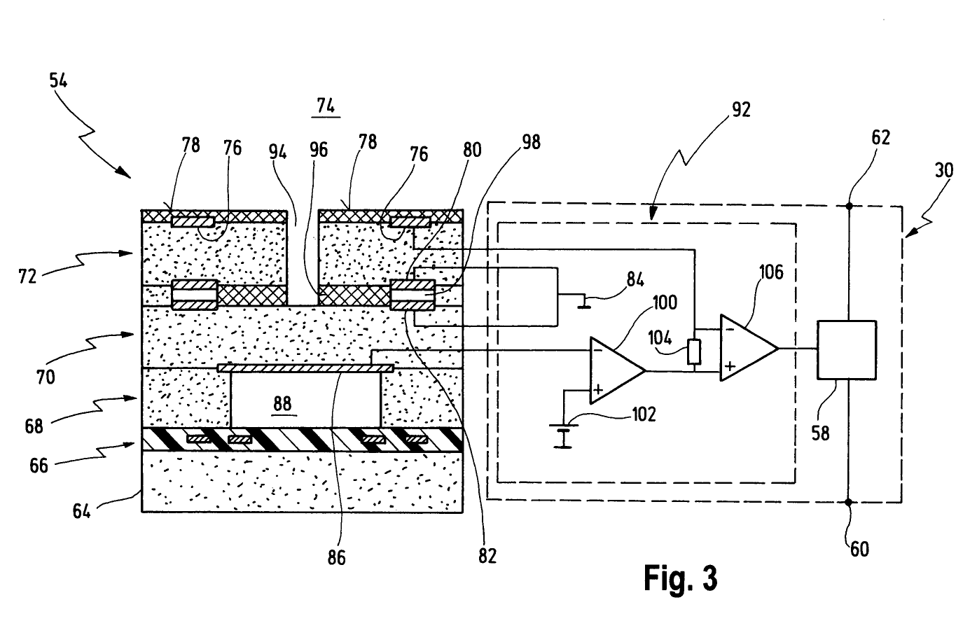

FIG. 3 shows exhaust gas sensor 54 having a modified operating and analyzing circuit 92 which operates exhaust gas sensor 54 as a broadband sensor. Exhaust gas 74 reaches a volume 98 (measuring gap) via an exhaust gas opening 94 and a gas-permeable porous diffusion barrier 96 so that an oxygen concentration materializes at Nernst electrode 82 and inner pump electrode 80. A potential, differing from reference potential 84, which is supplied to an inverting input of an operational amplifier 100, results at reference electrode 86 when the oxygen concentration in volume 98 differs from the oxygen concentration in reference channel 88. A reference voltage of, for example, 450 mV, which is generated by a voltage source 102, is applied to the non-inverting input of operational amplifier 100.

If the voltage between the inverting input and the non-inverting input of operational amplifier 100 deviates from zero, operational amplifier 100 generates a current through measuring shunt 104 to outer pump electrode 76, the current transporting oxygen ions from exhaust gas 74 into volume 98, or transporting oxygen ions from volume 98 to exhaust gas 74. The current direction depends on the sign of the voltage between the inverting and the non-inverting input of operational amplifier 100. In this way, operational amplifier 100 adjusts the oxygen concentration in volume 98 to a value at which the potential difference between its inverting input and the non-inverting input disappears. This is the case at a Nernst voltage of 450 mV between Nernst electrode 82 and reference electrode 86. Operational amplifier 100 thus generates a pump current which keeps the oxygen concentration in volume 98 at a constant value.

Since the oxygen concentration in volume 98 via diffusion barrier 96 is affected by the oxygen concentration in exhaust gas 74, the pump current, necessary for maintaining a constant oxygen concentration in volume 98, depends on the oxygen concentration in exhaust gas 74. The voltage drop, generated by the pump current across shunt 104, is detected by operational amplifier 106 as the measure for the oxygen concentration in exhaust gas 74 and is transferred to computer 58. The pump current varies constantly over the oxygen concentration in exhaust gas 74. The circuit of exhaust gas sensor 54 shown in FIG. 3 makes exhaust gas sensor 54 predestined for use as a broadband control sensor at the installation point of exhaust gas sensor 48 in FIG. 1.

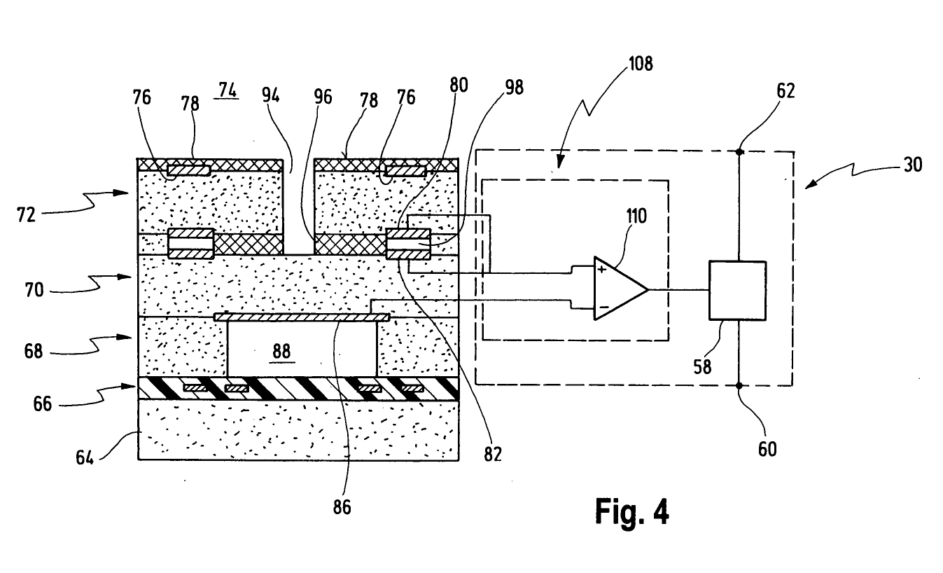

FIG. 4 shows an embodiment in which an operating and analyzing circuit 108 makes exhaust gas sensor 54 predestined for use as a reference sensor. Reference electrode 86 is, as in the object of FIG. 2, connected to the inverting input of an operational amplifier 110. Deviating from the object of FIG. 2, the inverting input of operational amplifier 110 is not connected to the outer pump electrode, but rather to Nernst electrode 82 and/or to inner pump electrode 80. Therefore, operational amplifier 110 measures a Nernst voltage which materializes due to a difference in the oxygen concentrations in reference channel 88 and in volume 98. Since the oxygen concentration in volume 98 via diffusion barrier 96 is determined by the oxygen concentration in exhaust gas 74, the Nernst voltage detected by operational amplifier 110 forms a measure of the oxygen concentration in exhaust gas 74.

Since diffusion barrier 96 generally has a higher diffusion resistance than protective layer 78, sensor 54 responds more slowly to changes in the oxygen concentration in exhaust gas 74 when connected according to FIG. 3 than when connected according to FIG. 2. This plays only a secondary role when exhaust gas sensor 54 is positioned at the point of exhaust gas sensor 50 in FIG. 1, since delays occur anyway at this installation point due to upstream catalytic converter volume 44 and because at this installation point rapidness is less essential than high accuracy of oxygen concentration detection. The accuracy of the inner pump electrode/Nernst electrode is particularly high because the upstream catalytic converter eliminates chemical imbalances to a large extent and, in addition, because the chemical/catalytic strain on the inner pump electrode/Nernst electrode is very low due to the upstream diffusion barrier. Outer pump electrode 76 is not connected to the operating and analyzing circuit in this embodiment.

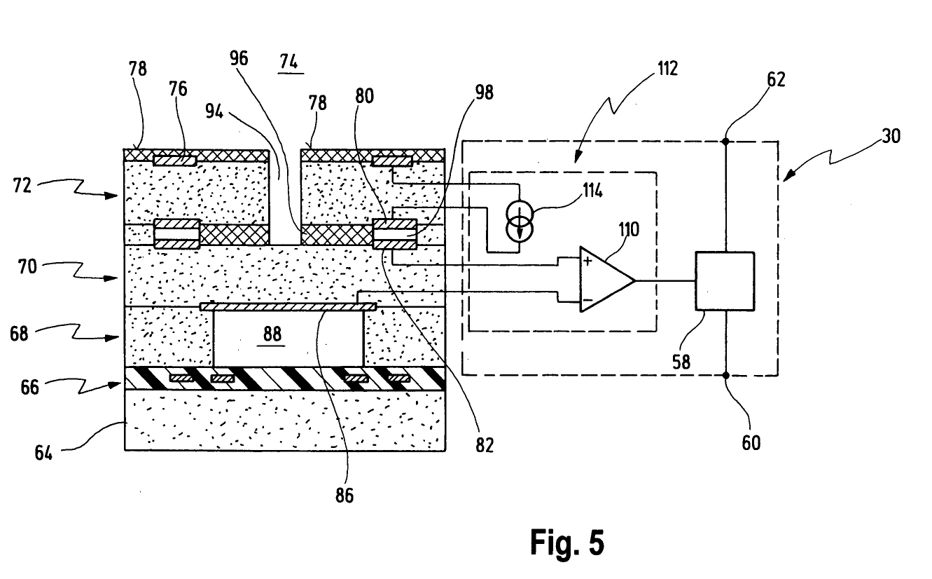

FIG. 5 shows sensor 54 having an operating and analyzing circuit 112 which allows use of sensor 54 at the location of exhaust gas sensor 52 downstream from an NOₓ storage catalytic converter 46 according to FIG. 1. In an arrangement of a Nernst sensor having a connection according to FIG. 2, tests have shown that the Nernst sensor jumps already on a “rich” indication, even though the provided gas still has excess oxygen. The signal curve thus shows an over-sensibility response. Such a breakthrough must be attributed to a malfunction of the Nernst sensor (methane shift) and not to an oxygen shortage downstream from storage catalytic converter 46. It has been shown specifically in a certain storage catalytic converter that in a regeneration taking place due to a rich exhaust gas atmosphere at the catalytic converter entry, a methane peak occurred downstream from the storage catalytic converter in which the Nernst sensor, despite proven oxygen excess at the catalytic converter exit (e.g., lambda=1.003), already indicates richness. If a further catalytic converter volume would be placed upstream from the Nernst sensor, then a jump at lambda equal to 1 would be achieved at best without the pump shift according to the present invention. However, it is to be expected that temporary, relatively harmless richness breakthroughs occur at lambda=0.997. These richness breakthroughs, which cannot be filtered out using a conventional ideal lambda =1.000 sensor, may be eliminated through the established pump shift. Methane shifts of the sensor as well as temporary richness breakthroughs through the catalytic converter may be compensated by the pump shift, thereby avoiding undesirable responses of the control.

Such an error indication is countered in the object of FIG. 5 in such a way that the Nernst voltage, similar to the object of FIG. 4, is indeed detected between Nernst electrode 82 and/or inner pump electrode 80 and reference electrode 86; at the same time, however, the oxygen concentration in volume 98 is increased by a defined injection of an oxygen-ion pump current from exhaust gas 74 to volume 98. Due to the defined oxygenation in volume 98, the characteristics curve of the Nernst cell, composed of electrodes 80/82 and 86 and intermediate foil 70 situated between them, is shifted in such a way that a richness indication does not occur at a lambda value of greater than or equal to 1, but rather at a lambda value of <1. In the object of FIG. 5, the defined pump current is generated by a constant current source or a constant voltage source 114 which is connected to outer pump electrode 76 and inner pump electrode 80. The circuit is closed via the solid electrolyte in pump layer 72, the current in the solid electrolyte being carried by oxygen ions.

Alternatively to the injection of a defined pump current, sensor 54 may be operated as a broadband sensor corresponding to the object of FIG. 3, an increased oxygen concentration in volume 98 being controlled due to the selection of the reference voltage supplied by voltage source 102. In contrast, the embodiment according to FIG. 5 has the advantage that the relatively expensive control loop including operational amplifier 100 and voltage source 102 according to FIG. 3 is not needed. In the embodiment according to FIG. 5, one additionally obtains a jump function at a completion of the regeneration phase which is noticeable due to an oxygen shortage downstream from storage catalytic converter 46.

The present invention has been exemplified here using a sensor configuration having a reference air channel and a vertical arrangement of the pump cell and the Nernst cell. It shall be understood that the present invention is not limited to such a configuration. The Nernst cell may be situated laterally downstream from the pump cell, for example. The reference air supply does not have to take place via a special channel, but may rather be implemented via a porosity of the printed conductor belonging to this electrode.

1. A sensor device for detecting an oxygen concentration at different points of an exhaust system of an internal combustion engine, comprising:
a first exhaust gas sensor situated upstream from a catalytic converter volume and for providing a first signal for a rapid fuel/air ratio control loop of the internal combustion engine;
a second exhaust gas sensor situated downstream from the catalytic converter volume and for providing a second signal, each one of the first exhaust sensor and the second exhaust sensor including:
an outer pump electrode,
an inner pump electrode,
a Nernst electrode, and
a reference electrode;
a first operating and analyzing circuit connected to the first exhaust gas sensor; and
a second operating and analyzing circuit connected to the second exhaust gas sensor, wherein:
at least one of the first operating and analyzing circuit and the second operating and analyzing circuit operating the respective connected one of the first exhaust gas sensor and the second exhaust gas sensor as a Nernst sensor.

2. The device as recited in claim 1, wherein the first operating and analyzing circuit operates the first exhaust gas sensor as a Nernst sensor and picks off a Nernst voltage as a difference in a potential of the outer pump electrode and a potential of the reference electrode.

3. The device as recited in claim 1, wherein:
the first operating and analyzing circuit operates the first exhaust gas sensor as a broadband sensor,
a pump cell is formed by at least one of:
the outer pump electrode and the inner pump electrode, and
the Nernst electrode and an ion-conductive volume situated between the outer pump electrode, the inner pump electrode, and the Nernst electrode,
a Nernst cell is formed by at least one of the Nernst electrode and the inner pump electrode together with the reference electrode and the ion-conductive, and
the pump cell is operated by a pump current that is dependent on a difference in a potential of at least one of the Nernst electrode and the inner pump electrode and a potential of the reference electrode.

4. The device as recited in claim 1, wherein the second operating and analyzing circuit operates the second exhaust gas sensor as a Nernst sensor.

5. The device as recited in claim 4, wherein the second operating and analyzing circuit operates the second exhaust gas sensor without its outer pump electrode being connected, as a reference sensor for a first control loop, the second operating and analyzing circuit picking off a Nernst voltage as a difference in a potential of at least one of the Nernst electrode and the inner pump electrode and a potential of the reference electrode.

6. The device as recited in claim 4, wherein the second operating and analyzing circuit operates the second exhaust gas sensor using a pump current that flows via the outer pump electrode, and picks off a Nernst voltage as a difference in a potential of at least one of the Nernst electrode and the inner pump electrode and a potential of the reference electrode.

7. The device as recited in claim 6, wherein the second operating and analyzing circuit provides a constant pump current.

8. The device as recited in claim 6, wherein the second operating and analyzing circuit applies a constant pump potential to the outer pump electrode.

9. The device as recited in claim 1, wherein the first exhaust gas sensor and the second exhaust gas sensor are identical.

10. The device as recited in claim 1, wherein the first exhaust gas sensor differs from the second exhaust gas sensor only with respect to a modified diffusion resistance of a diffusion barrier.

11. The device as recited in claim 1, wherein the Nernst electrode and the inner pump electrode are implemented as a combined electrode.

12. A method for detecting an oxygen concentration at different points of an exhaust system of an internal combustion engine, comprising:
providing a first exhaust gas sensor situated upstream from a catalytic converter volume and for providing a first signal for a rapid fuel/air ratio control loop of the internal combustion engine;
Providing a second exhaust gas sensor situated downstream from the catalytic converter volume and for providing a second signal, each one of the first exhaust sensor and the second exhaust sensor including:
an outer pump electrode,
an inner pump electrode,
a Nernst electrode, and
a reference electrode;
providing a first operating and analyzing circuit connected to the first exhaust gas sensor;
providing a second operating and analyzing circuit connected to the second exhaust gas sensor; and
causing at least one of the first operating and analyzing circuit and the second operating and analyzing circuit to operate the respective connected one of the first exhaust gas sensor and the second exhaust gas sensor as a Nernst sensor.
